(19) United States
(12) Patent Application Publication
(10) Pub. No.: US 2023/0419860 A1
(43) Pub. Date: Dec. 28, 2023

(54) DEVICE FOR MECHANICALLY RENDERING BRAILLE USING MOTION HAPTIC STIMULATION TECHNOLOGY

(71) Applicant: Educational Media Consulting, LLC, Troy, VA (US)

(72) Inventor: Gerald Drake, Palmyra, VA (US)

(21) Appl. No.: 18/233,441

(22) Filed: Aug. 14, 2023

Related U.S. Application Data
(63) Continuation-in-part of application No. 17/850,095, filed on Jun. 27, 2022, now abandoned.
Application No. 17/850,095 is a continuation of application No. 16/804,688, filed on Feb. 28, 2020, now Pat. No. 11,373,548.
Application No. 16/804,688 is a continuation of application No. 16/058,860, filed on Aug. 8, 2018, now Pat. No. 10,692,400.
(60) Provisional application No. 62/542,530, filed on Aug. 8, 2017.

(51) Int. Cl. G09B 21/00

(52) U.S. Cl. CPC G09B 21/004; G09B 21/001; G09B 21/003; G09B 21/00; B41J 3/32

(57) ABSTRACT

A device comprising rotating cylindrical shafts to create a virtual sensation of Braille text by integrating a microprocessor with microdrive actuators. The microdrive's shafts are flush or level with the device's display surface thereby emulating the standard diameter and feel of a Braille dot or Braille space. This sensation of a rotating dot is the result of the top face of the shafts positioned flush with the device's display surface. Actuators that alternate between rotating shafts and shafts at rest produce Braille cell dots and spaces, respectively.

### CROSS-REFERENCE TO RELATED APPLICATIONS

The present application is a continuation-in-part of and relies on the disclosures of and claims priority to and the benefit of the filing date of U.S. application Ser. No. 17/850,095, filed Jun. 27, 2022, which is a continuation of and relies on the disclosures of and claims priority to and the benefit of the filing date of U.S. application Ser. No. 16/804,688, filed Feb. 28, 2020, which is a continuation of and relies on the disclosures of and claims priority to and the benefit of the filing date of U.S. application Ser. No. 16/058,860 filed Aug. 8, 2018, which relies on the disclosures of and claims priority to and the benefit of the filing date of U.S. Provisional Application No. 62/542,530, filed Aug. 8, 2017. The disclosures of those applications are hereby incorporated by reference herein in their entireties.

### FIELD OF THE INVENTION

The field generally relates to Braille devices for blind and visually impaired individuals, and more particularly to electronic reader tablets for displaying Braille content.

### BACKGROUND OF THE CURRENT INVENTION

The present invention is directed to a haptic system of rotating cylindrical shafts topped with, in aspects, round caps to create a virtual sensation of Braille text (or in cases, images) by integrating a microprocessor (also referred to herein as microcomputer or processing unit or microprocessing unit, in aspects) with microdrive actuators (also referred to herein as micro motors, micro drives, or drives). Specifically, the present invention is directed to a device whereby coded text data is inputted to a microprocessor that regulates or otherwise instructs mechanical microdrive actuators. The microdrive actuator's shafts are, in aspects, crowned with plastic cylindrical caps the diameter of which is 1.44 mm, the standard diameter of conventional paper embossed Braille. The top face of the caps or tops of the shafts are disc-shaped and are positioned flush or substantially flush or level with the device's display surface (also referred to herein as an output user interface), thereby emulating the standard diameter and/or feel of a Braille dot or Braille space in two or three dimensions. In aspects, flush or substantially flush (or level) means allowing for variances that would be expected by one of ordinary skill in the art manufacturing the device, and/or flush to a degree that a Braille dot (or space) could be read and/or perceived by a user of the device. In certain embodiments, the Braille dots of the present invention are represented as flat discs, or in some cases may have texture. Unlike conventional embossed paper Braille or the current designs of refreshable Braille readers, the Braille dot's dimension for height is absent in the present invention. It is, in aspects, the rotation of the drive's shaft that spins the caps and simulates the sensation of a Braille dot that is felt with the fingertips. In aspects, the dots can raise and lower, as well as spin. This sensation of a two dimensional rotating dot is the result of the top face of the capped shafts positioned flush or level with the device's display surface. A drive shaft/cap that is not spinning is at-rest and perceived as a Braille space. The spinning or at-rest caps, six to a cell, translate coded text or image files into Braille text that can be read on an output user interface. In embodiments, six caps are aligned in a two column-three row configuration to resemble a conventional Braille cell/character. The currently claimed Braille e-reader device can display up to 1000 Braille cells or characters (e.g., such as letters, numbers, punctuations, symbols, indicators), or more or less, and is refreshable—that is, it can advance the text (or image) to the next page(s) of Braille or returns to the previous page(s) on demand by, for example, toggling a navigation button on the device or using a voice command.

The present invention is expected to provide services and features to the blind and visually impaired that are currently available to users of Nooks and Kindle, by way of example. The advantages of Braille text displays (also referred to herein as a e-readers or reader tablets) over audio books for the visually impaired are significant. Braille text provides a user with a “physical” reading experience, an advantage because the individual can re-read and search surrounding words for contextual clues. When reading, a reader progresses at his own pace, and he/she decides on the pronunciation of character and place names. It is an active, not a passive experience. On the other hand, when listening to audio books, the narrator sets the pace and decides on pronunciations, and the listener hears the characters in the narrator's voice only. When the visually impaired read Braille, the scenes and characters of the narrative are more vibrant than listening to storytelling because the reader more fully engages their imagination to create the story. Reading Braille specifically stimulates both the visual and tactile cortex. When scientists taught sighted people to read Braille, a complex tactile task, they found that the activity activated the visual cortex as well as the tactile one. Most importantly, Braille books give the blind a greater opportunity for meditation and thinking while they read.

Currently, the price of Braille e-readers range from $3,500 to $15,000, depending on the number of characters displayed and the functionality of the device. Current technology used to build refreshable Braille displays is still dependent on the old model of creating a three dimensional haptic sensation for the user by employing electronic or pneumatic methods to raise and lower small plastic pins on a grid matrix, forming Braille characters. The method proposed herein, in aspects, is two dimensional, less complex in design, and more affordable. In aspects, the current device explained herein will allow users to read entire pages of text. The bulkiness of bound paper Braille books, which often consist of several volumes to convert a single book of conventional typeface, makes it a challenge to carry them. This is especially a problem for educational textbooks when conventional text is translated to Braille. Buying published Braille “books” often takes many months to complete the transaction.

The invention described herein provides for refreshable Braille displays possible of being programmed and manufactured more efficiently and for much less money than currently available Braille e-readers, allowing for such technology to be more vastly disseminated to the visually-impaired community. Most currently available refreshable Braille displays use piezoelectric actuation mechanisms to move the pins that generate dot displays denoting each character. The piezoelectric actuation mechanism cells require continuously applied voltage to move the pins up and down. The microdrive actuators in the inventive device explained herein draw voltage when they are turning, aspects.

### DESCRIPTION OF RELATED ART

The following references are incorporated herein by reference.

U.S. Publication No. 2011/0111375:

U.S. Publication No. 2011/0111375 describes a “single-unit portable Braille device according to claim 1, . . . each Braille cell including a plurality of electromechanically controlled pins, each pin being selectively raiseable and lowerable in response to electrical commands originating from the processing unit.” A user detects Braille characters through sensation of a three dimensional pin.

U.S. Publication No. 2012/0050172:

The Abstract for U.S. Publication No. 2012/0050172 states that the invention is “a system and method for a touch display system. The touch display system includes: a flat touch display assembly including a matrix of flat Braille pixels, wherein each flat Braille pixel is operable to be placed in one of two states. A heating source is selectively connected to each flat Braille pixel. A cooling source selectively connected to each flat Braille pixel. The flat Braille pixels are configured to represent images to touch by selective heating and cooling thereof.”

U.S. Publication No. 2015/0262509

Claim 11 for 0262509 states “11. The single-unit portable Braille device according to claim 1, wherein the refreshable Braille display comprises a linear array of one or more rows of adjacent Braille cells, each Braille cell including a plurality of electromechanically controlled pins, each pin being selectively raiseable and lowerable in response to electrical commands originating from the processing unit.”

U.S. Pat. No. 7,432,912

The Abstract for 7,432,912 states the adaptation of a regular pocket size computer for use by a visually impaired person is provided . . . . The tactile keyboard includes a membrane having raised keys on one side and corresponding screen activating tips on the other. Conversely, the invention described in this application comprises a tablet or tablet computer with a tactile interface display and microprocessor that is approximately 11 inches wide and 11 inches tall, although the device may be smaller or larger.

U.S. Pat. No. 8,686,951

Claim(s) for 8,686,951 describe an apparatus and method for providing and configuring an elevated, indented, or texturized display device is disclosed. Processes are also given involving elevated, indented, or texturized portions of a display device. By providing an elevated, indented, or texturized display device enhanced input/output functions are provided.

### SUMMARY OF THE INVENTION

Braille is the written language of visually impaired readers who cannot see printed material. Readers of Braille are required to use their sense of touch by running a finger over a sequence of spaces and raised dots. A Braille character consists of six alternating spaces or dots configured in a grid having three and two columns. By alternating the raised dots with different combinations of the spaces within the cells, each alphanumeric character in English and other languages can be created. Traditional Braille has been created by embossing paper with arrays or cells of spaces and dots, each cell representing a different alphabetical character or number.

Literacy—the ability to read and write—is vital to a successful education, career, and quality of life in today's world. Although learning to read and write in traditional ways may not be possible when you cannot see print on a page, there are many other paths to becoming literate. Learning to read and write in Braille can make a dramatic difference in the life of a visually impaired child or adult. Braille is an irreplaceable and modern method for literacy among the millions of visually impaired. Current refreshable Braille readers display only one line of text and therefore are not conducive to reading. The present invention as described herein is, in aspects, directed to 40 lines of 25 cells or characters.

In embodiments, the device described herein can be capable of generating braille characters using microdrive actuators attached to spinning shafts—each shaft representing a braille dot—to create certain Braille characters. The actuators thereby activate driveshafts which are aligned in a Braille pattern, character, or cell. The microdrive actuator's shafts are, in aspects, crowned with 1.44 mm plastic cylindrical caps, the top face of which are flush or level with the device's display surface (also referred to herein as an output user interface), thereby emulating the standard diameter and feel of a Braille dot or Braille space in two dimensions. The Braille matches or approximates written text, images, patterns, or other information, input into the device, which a computer processing unit uses to instruct the microdrive actuators.

### BRIEF DESCRIPTION OF THE DRAWINGS

The accompanying drawings illustrate certain aspects of some of the embodiments of the present invention, and should not be used to limit or define the invention. Together with the written description the drawings serve to explain certain principles of the invention.

FIG. 1 is a perspective rendering of the reading surface of the tablet display cells as 2-dimensional or 3-dimensional displays of various tactile circles, squares, and other shapes, objects, and images.

FIG. 2 is a rendering of microdrive actuator speed control which can allow users to find the optimal tactile sensation of the cell dots or spinning actuator discs by reducing or increasing the rotation speed of the microdrive shafts to find the most comfortable setting.

FIG. 3 is a perspective rendering of one or more touch sensors being activated by physical contact with an individual braille reader's finger(s) and will respond to the fingers swiping or otherwise interacting with the braille dots by turning on a programmable number of preceding and/or proceeding rows of braille.

FIG. 4 is a perspective rendering of the device showing microdrive actuators, each microdrive actuator causing the cap to spin, or rotate.

FIG. 5 is a rendering showing microdrive actuator speed control than can allow users to find the optimal tactile sensation of the cell dots or spinning actuator discs by reducing or increasing the rotation speed of the microdrive shafts to find the most comfortable setting.

FIG. 6 is a rendering showing one or more touch sensor which can be activated by physical contact with an individual braille reader's finger(s) and will respond to the fingers swiping or otherwise interacting with the braille dots by turning on a programmable number of preceding and/or proceeding rows of braille.

FIG. 7 is a rendering showing when the device is turned on and translating written text to Braille, each microdrive actuator causes the cap to spin, or rotate. It is a user's cumulative experience of touching the spinning caps flush or level with the interface, which correspond to the Braille dots.

### DETAILED DESCRIPTION OF THE INVENTION

In the following description some elements may not be indicated on some figures if they were already identified in preceding figures. It should also be understood herein that the elements of the drawings are not necessarily depicted to scale, since emphasis is placed upon clearly illustrating the elements and structures of the present embodiments.

The present invention has been described with reference to particular embodiments having various features. It will be apparent to those skilled in the art that various modifications and variations can be made in the practice of the present invention without departing from the scope or spirit of the invention. One skilled in the art will recognize that these features may be used singularly or in any combination based on the requirements and specifications of a given application or design.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

The input/output interfaces may be used in conjunction with the computer-executable code and electronic databases. The user interface may allow a user to perform these tasks through the use of Braille equivalents of text fields, check boxes, pull-downs, command buttons, and the like. A skilled artisan will appreciate how such features may be implemented for performing the tasks of this disclosure. The user interface may optionally be accessible through a computer connected to the internet. In one embodiment, the user interface is accessible by typing in an internet address through an industry standard web browser and logging into a web page. The user interface may then be operated through a remote computer (client computer) accessing the web page and transmitting queries or receiving output from a server through a network connection.

In embodiments, the invention described herein provides for refreshable Braille displays possible of being programmed and manufactured more efficiently and less expensively than currently available Braille e-readers, allowing for such technology to be more vastly disseminated to the visually-impaired community.

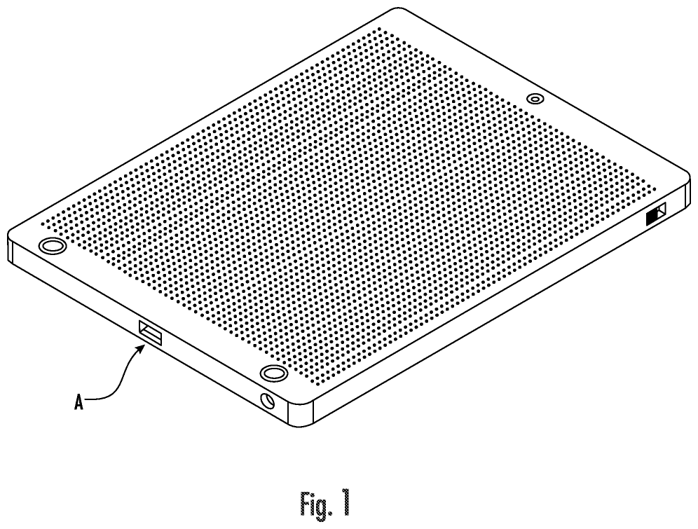

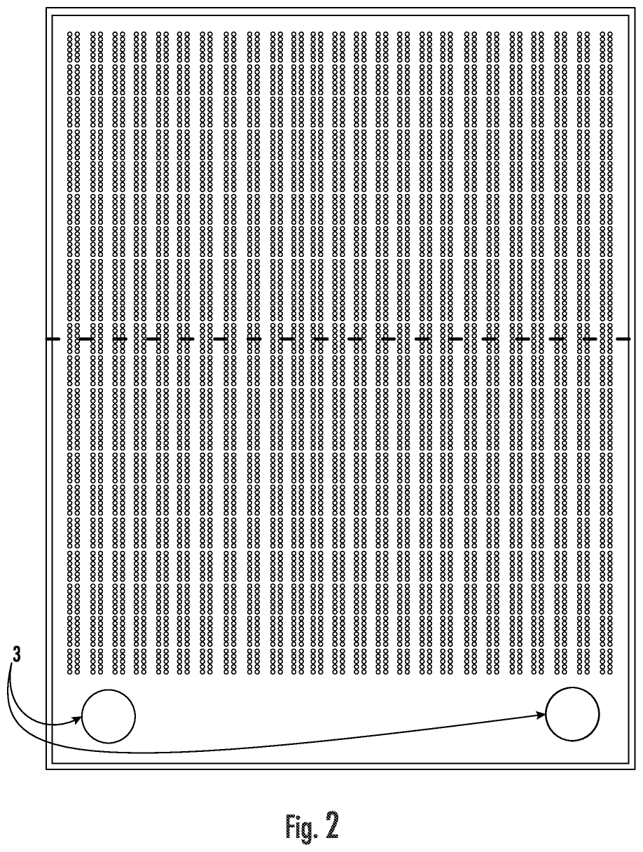

FIG. 1 is a rendering of the device comprising a tablet or tablet computer with a tactile interface display and microprocessor that is enclosed in a light-weight casing approximately 11 inches wide and 11 inches tall, although the device may be smaller or larger. In FIG. 1, the device also comprises a means of inputting data A, such as by wired or wireless communication or an information port (e.g., a USB port or Bluetooth). It is approximately 1.5 inches thick but in some cases may be thinner or thicker. In FIG. 2, the tablet display may conform to the standard Braille cell configuration and cell array per page. In FIG. 2, each line may be 25 cells in length, with 40 lines per page, a total of 1000 cells. All lines may be counted from the top of the page, regardless of whether or not they contain Braille. The device may allow for more or less cells or characters. In addition to the 1000 cells of Braille, the device may comprise a speaker and a microphone for a built-in “intelligent assistant” that enables users to speak voice commands to operate the Braille device and its computer software applications (e.g., voice recognition software). In other aspects, the device may comprise internal or external batteries or power sources, sensors, cameras, memory, processors, and means of communication, such as an antenna and wireless communication capabilities (e.g., Bluetooth and Wi-Fi). In FIG. 2, the device can have a microdrive actuator speed control adjustment mechanism 3 which can allow users to find the optimal tactile sensation of the cell dots or spinning actuator discs by reducing or increasing the rotation speed of the microdrive actuator shafts to find the most comfortable setting.

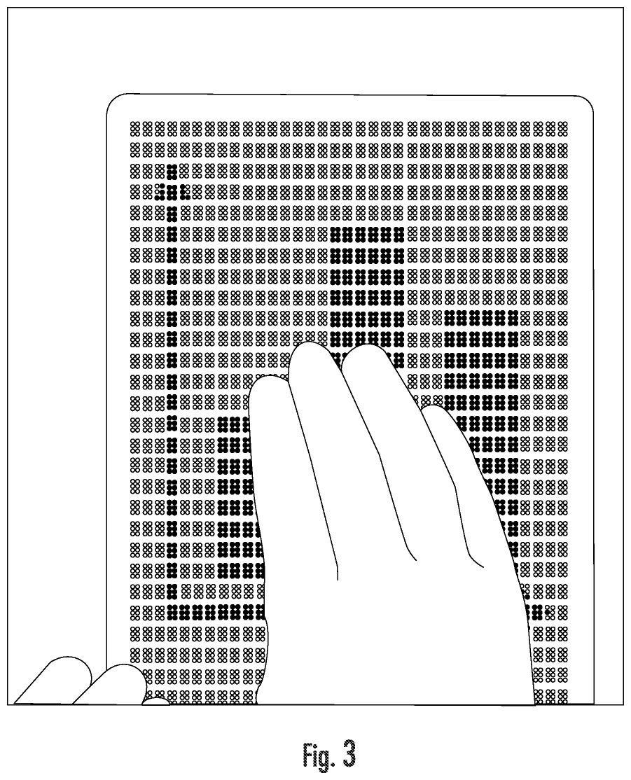

In embodiments, the reading surface of the tablet can display cells or characters of braille as well as 2-dimensional or 3-dimensional displays of various tactile circles, squares, and other shapes, objects, and images. Braille cells or characters are formed using 2 column by 3 row matrices. Tactile images can be formed using a pointillism technique to create shapes and fields. This inventive technique can employ some, all, or each braille dot, through its off or on status, to create patterns of lines and fields to form an image, by way of example. In embodiments, this can be accomplished by programming (e.g., independently programming) some, all, or each of the tablet's braille microdrive actuators (in cases, 6000 braille microdrive actuators) to on or off status. A file format can deliver the image to a microprocessor which will control the status of each microdrive actuators to be part of a field or line that compiles the image. The result is a tactile sensation created by the braille dots that allows blind braille readers to explore images of, by way of example only, graphs, objects, symbols, and anything else that can be rendered in 2-dimensional or 3-dimensional form. As shown in FIG. 3, the reading surface of the tablet can display cells as 2-dimensional or 3-dimensional displays of various tactile circles, squares, and other shapes, objects, and images.

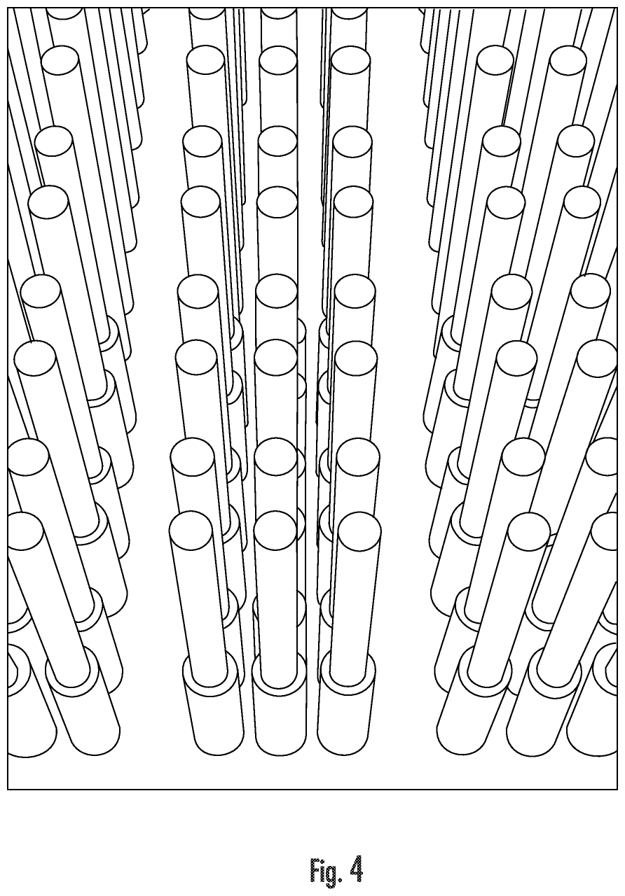

In embodiments, the refreshable braille tablet will employ 6000 microdrive actuators to create 1000 cells of braille. In embodiments, each cell employs 6 microdrive actuators in a 2×3 array driven by, for example, MEMS actuators. In aspects, each of these six microdrive actuator cell arrays can be bundled in a casing that allows a 2×3 configuration of microdrive shafts to be contained in a single container. In embodiments, six pack casing can constructed with material to shield magnetic radio frequency interference that might be generated by the microdrive actuators. In other embodiments, less or more than 6000 microdrive actuators can be used depending on how many cells of braille are used on the tablet device. In embodiments, as shown in FIG. 4, each of these six microdrive actuator cell arrays can be bundled in a casing that allows a 2×3 configuration of microdrive actuator shafts to be contained in a single container.

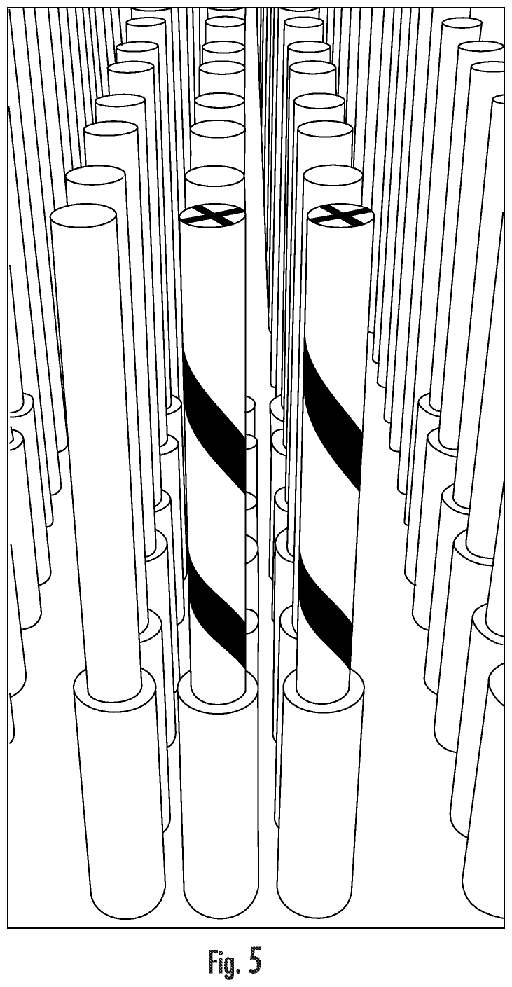

In embodiments, the microdrive actuator's surface disc rotational speed can be controlled by incorporating a rheostat working as a variable resistor, by way of example. This function of the braille reading surface allows readers to customize the tactile sensation of the microdrive actuators to improve resolution of each actuator's spinning disc surface. Microdrive actuator speed control will allow users to find the optimal tactile sensation of the cell dots or spinning actuator discs by reducing or increasing the rotation speed of the microdrive shafts to find the most comfortable setting. Optimal can be defined as dot sensation that has the highest resolution and produces the least amount of braille fatigue for the user. The adjustment mechanism can be one or more of a dial, knob, switch, lever, slide, key, button, or other physical mechanism understood by one of skill in the art that could be used to indicate a desire to increase or decrease speed. In embodiments, the adjustment mechanism can be via voice control whereby a user will command the spinning speed to increase or decrease using a voice command and the processor will instruct the spinning speed according to the command. As shown in FIG. 5, microdrive actuator speed control will allow users to find the optimal tactile sensation of the cell dots or spinning actuator discs by reducing or increasing the rotation speed of the microdrive shafts to find the most comfortable setting.

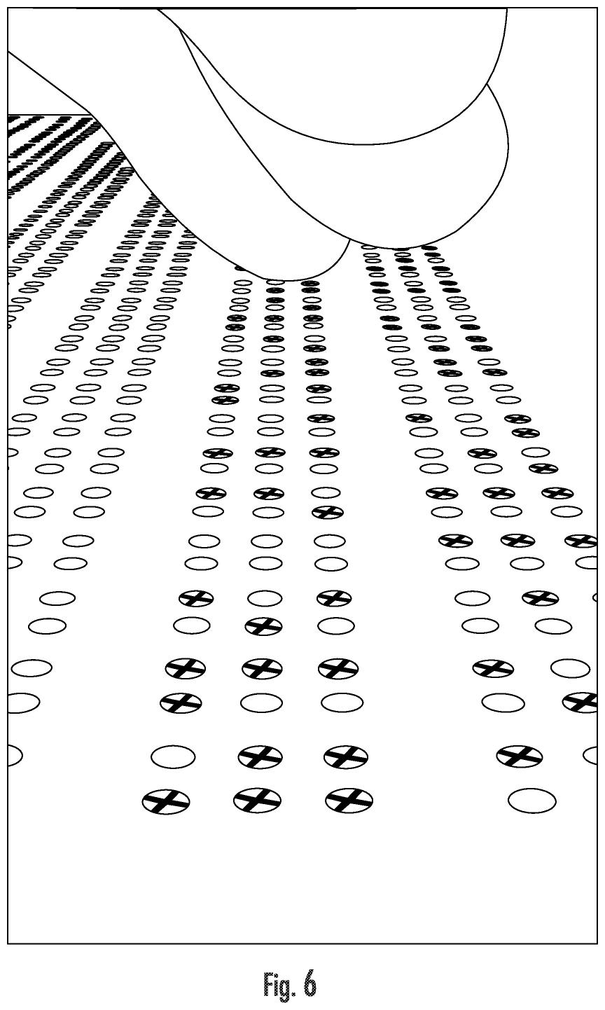

In embodiments, one or more touch sensor can be embedded or otherwise included in the tablet device or on the tablet reading surface. The one or more touch sensor can be integrated with the microdrive actuators. In aspects, the one or more touch sensor is activated by physical contact with an individual braille reader's finger(s) and will respond to the fingers swiping or otherwise interacting with the braille dots by, for example, turning on a programmable number of preceding and/or proceeding rows of braille. In aspects, readers' fingertips will be detected by the one or more touch sensor and will activate a reduced number of rows of braille cells behind and in front of fingertip contact thus saving battery power. In an example, the one or more touch sensor can take haptic input from the user and determine which rows should be activated to anticipate ready forward or returning to braille text that has been read for further examination and reflection. In aspects, each physical stroke that the one or more touch sensor records or senses can be sent to a microprocessor that controls the braille displayed according to the reader's finger position on the reading surface. In embodiments, a braille row can turn on when the one or more touch sensor senses a user's fingertip on that row. This can also work on a row by row basis, a multiple row by multiple row basis, and/or on a braille dot by braille dot basis. As shown in FIG. 6, one or more touch sensor can be activated by physical contact with an individual braille reader's finger(s) and will respond to the fingers swiping or otherwise interacting with the braille dots by turning on a programmable number of preceding and/or proceeding rows of braille.

The Braille characters are created, in aspects, by shafts topped by 1.44 mm plastic caps that are attached to microdrive actuator shafts. These caps may be made of other material in addition to plastic, and may be longer or shorter but will preferably adhere to the standard diameter of Braille dots. In embodiments, microdrive actuator assemblies can comprise mounts and 3 individual actuators. In embodiments, two assemblies can produce a conventional six dot Braille cell/character for the device.

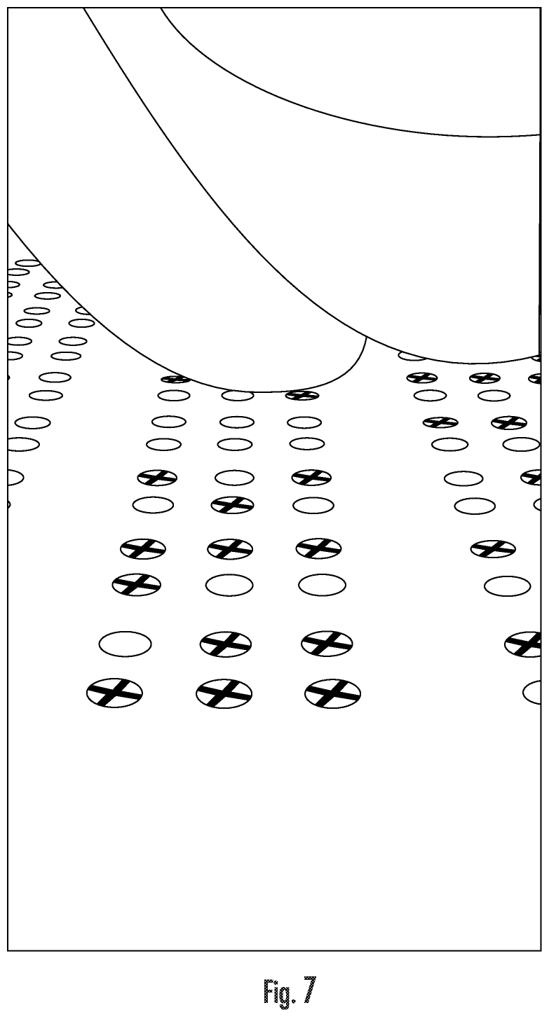

As shown in FIG. 7, when the device is turned on and translating written text to Braille, each microdrive actuator can cause the cap to spin, or rotate. It is a user's cumulative experience of touching the spinning caps flush or level with the interface, which correspond to the Braille dots. When the caps are at rest, the user senses a space in the Braille cell. Dots and spaces combine to create the perception of a Braille alphanumeric character. By alternating spinning caps and caps at rest, the user will “read” the virtual dots (and spaces) as a Braille character. As shown in FIG. 7, when the device is turned on and translating written text to Braille, each microdrive actuator causes the cap to spin, or rotate. Spin and rotate are used interchangeably herein. It is a user's cumulative experience of touching the spinning caps flush or level with the interface, which correspond to the Braille dots.

In aspects, the display surface will use sensors to detect when the device is in use. “In use” is defined as when the device is powered up and/or the user is reading Braille text (or anything else) on the tablet display (e.g., the user's hand or fingers are in contact with the display). When the device is “in use” mode the microdrive actuators can be powered up. In embodiments, when the user removes his/her hands from the display surface (or the device), the device will sense this and power down to save battery life.

In another embodiment of a method of using the tablet device, the refreshable braille tablet can deliver, for example, on-demand, self-directed learning modules for teaching braille reading. The learning modules can employ a voice activation or voice control microprocessor or mechanism that delivers braille instruction and allows the user to activate or control or interact with the learning modules' content by using their voice, as opposed to pressing buttons to use a touchscreen interface device. In aspects, a microprocessor can use artificial intelligence to recognize and process language commands and queries using a software layer. Chatbots with artificial intelligence systems can guide users with personalized, just-in-time, or real-time feedback or assistance. These chatbots can answer questions about course content or structure. This immediate feedback system can help users keep track of their own learning while keeping them motivated and engaged. The voice activation and interaction can employ chatbot technology and bypass any requirement for physical controls on the tablet (e.g. on/off switch). It can also allow the braille learner to interact with directions/commentary of a braille instructor during lessons. The chatbot can suggest questions about the content and areas for future inquiry that are customized for each user. It can change the reading level of the braille text and also include supplemental tactile images and tactile animations to help users understand the braille instruction.

Testing of a Prototype to Test Two Dimensional Braille Concept

A model of the device was created to prototype and test the concept of a two-dimensional rotating disc serving as a Braille dot instead of the conventional three dimensional raising/lowering pin. A five Braille cell device was fabricated. The intent was to have a blind subject use the prototype to determine if he or she could identify alphanumeric characters using the prototype's rotating microdrive shafts aligned in the standard two-dot column by three-dot row creating a conventional six dot cell. The subject was not told in advance what alphanumeric characters were to be displayed. The subject was a blind 28 year old employed by a state agency for the blind and visually impaired who taught Braille. The subject was able to identify each character correctly in all attempts.

Embodiments of the invention also include a computer readable medium comprising one or more computer files comprising a set of computer-executable instructions for performing one or more of the calculations, steps, processes and operations described and/or depicted herein. In exemplary embodiments, the files may be stored contiguously or non-contiguously on the computer-readable medium. Embodiments may include a computer program product comprising the computer files, either in the form of the computer-readable medium comprising the computer files and, optionally, made available to a consumer through packaging, or alternatively made available to a consumer through electronic distribution. As used in the context of this specification, a “computer-readable medium” is a non-transitory computer-readable medium and includes any kind of computer memory such as floppy disks, conventional hard disks, CD-ROM, Flash ROM, non-volatile ROM, electrically erasable programmable read-only memory (EEPROM), and RAM. In exemplary embodiments, the computer readable medium has a set of instructions stored thereon which, when executed by a processor, cause the processor to perform tasks, based on data stored in the electronic database or memory described herein. The processor may implement this process through any of the procedures discussed in this disclosure or through any equivalent procedure.

In other embodiments of the invention, files comprising the set of computer-executable instructions may be stored in computer-readable memory on a single computer or distributed across multiple computers. A skilled artisan will further appreciate, in light of this disclosure, how the invention can be implemented, in addition to software, using hardware or firmware. As such, as used herein, the operations of the invention can be implemented in a system comprising a combination of software, hardware, or firmware.

Embodiments of this disclosure include one or more computers or devices loaded with a set of the computer-executable instructions described herein. The computers or devices may be a general purpose computer, a special-purpose computer, or other programmable data processing apparatus to produce a particular machine, such that the one or more computers or devices are instructed and configured to carry out the calculations, processes, steps, operations, algorithms, statistical methods, formulas, or computational routines of this disclosure. The computer or device performing the specified calculations, processes, steps, operations, algorithms, statistical methods, formulas, or computational routines of this disclosure may comprise at least one processing element such as a central processing unit (i.e. processor) and a form of computer-readable memory which may include random-access memory (RAM) or read-only memory (ROM). The computer-executable instructions can be embedded in computer hardware or stored in the computer-readable memory such that the computer or device may be directed to perform one or more of the calculations, steps, processes and operations depicted and/or described herein.

Additional embodiments of this disclosure comprise a computer system for carrying out the computer-implemented method of this disclosure. The computer system may comprise a processor for executing the computer-executable instructions, one or more electronic databases containing the data or information described herein, an input/output interface or user interface, and a set of instructions (e.g. software) for carrying out the method. The computer system can include a stand-alone computer, such as a desktop computer, a portable computer, such as a tablet, laptop, PDA, or smartphone, or a set of computers connected through a network including a client-server configuration and one or more database servers. The network may use any suitable network protocol, including IP, UDP, or ICMP, and may be any suitable wired or wireless network including any local area network, wide area network, Internet network, telecommunications network, Wi-Fi enabled network, or Bluetooth enabled network. In one embodiment, the computer system comprises a central computer connected to the internet that has the computer-executable instructions stored in memory that is operably connected to an internal electronic database. The central computer may perform the computer-implemented method based on input and commands received from remote computers through the internet. The central computer may effectively serve as a server and the remote computers may serve as client computers such that the server-client relationship is established, and the client computers issue queries or receive output from the server over a network.

One skilled in the art will recognize that the disclosed features may be used singularly, in any combination, or omitted based on the requirements and specifications of a given application or design.

When an embodiment refers to “comprising” certain features, it is to be understood the embodiments can alternatively “consist of” or “consist essentially of” any one or more of the features. Other embodiments of the invention will be apparent to those skilled in the art from consideration of the specification and practice of the invention.

It is noted in particular that where a range of values is provided in this specification, each value between the upper and lower limits of that range is also specifically disclosed. The upper and lower limits of these smaller ranges may independently be included or excluded in the range as well. The singular forms “a,” “an,” and “the” include plural referents unless the context clearly dictates otherwise. It is intended that the specification and examples be considered as exemplary in nature and that variations that do not depart from the essence of the invention fall within the scope of the invention. Further, all of the references cited in this disclosure are each individually incorporated by reference herein in their entireties and as such are intended to provide an efficient way of supplementing the enabling disclosure of this invention as well as provide background detailing the level of ordinary skill in the art.

As used herein, the term “about” refers to plus or minus 5 units (e.g., percentage) of the stated value.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

As used herein, the term “substantial” and “substantially” refers to what is easily recognizable to one of ordinary skill in the art.

It is to be understood that the phraseology and terminology employed herein is not to be construed as limiting and are for descriptive purpose only.

It is to be understood that while certain of the illustrations and figure may be close to the right scale, most of the illustrations and figures are not intended to be of the correct scale.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

1. A device for generating braille characters comprising a display surface having a plurality of braille characters, wherein each of the plurality of braille characters includes a two-column by three-row configuration of braille dots, wherein each dot of the two-column by three-row configuration is provided by one or more microdrive actuators connected to a shaft, wherein the one or more microdrive actuators are capable of spinning the shaft, and wherein an end of the spinning shaft provides a tactile dot on the display surface of the device.

2. The device of claim 1, further comprising one or more touch sensors capable of activating all or a portion of one or more rows of braille characters.

3. The device of claim 1, wherein the plurality of braille characters are activated by a computer processing unit to generate one or more tactile patterns on the display surface.

4. The device of claim 3, wherein the tactile pattern represents an image, object, and/or shape.

5. The device of claim 1, further comprising an adjustment mechanism for increasing or decreasing a speed of the one or more spinning microdrive actuators.

6. The device of claim 1, wherein the end of the spinning shaft is crowned with a cylindrical cap.

7. The device of claim 1, wherein the end of the spinning shaft is crowned with a 1.44 mm cylindrical cap.

8. The device of claim 1, wherein the plurality of braille characters are in a 25 column by 40 row array.

9. The device of claim 1, wherein the display surface is capable of providing braille for one or more pages of conventionally displayed print or pixel text.
